(19) United States
(12) Patent Application Publication
(10) Pub. No.: US 2023/0250954 A1
(43) Pub. Date: Aug. 10, 2023

(54) OXYGEN TORCH CUTTING SYSTEM

(71) Applicant: Total Combustion IP Holdings, LLC, Palm Beach Gardens, FL (US)

(72) Inventors: Jacob Youngman, Palm Beach Gardens, FL (US); James Moore, Mogadore, OH (US); Jacob Wilson, North Palm Beach, FL (US); Powell Pace, Palm Beach Gardens, FL (US); Trevor Cost, Aurora, OH (US)

(21) Appl. No.: 17/932,131

(22) Filed: Sep. 14, 2022

Related U.S. Application Data
(60) Provisional application No. 63/306,866, filed on Feb. 4, 2022.

(51) Int. Cl. F23D 14/42; F23D 14/62

(52) U.S. Cl. CPC F23D 14/42; F23D 14/62

(57) ABSTRACT

Disclosed herein are embodiments of an oxygen torch cutting system. In one embodiment, the oxygen torch cutting system comprises a cutting torch supplied with an oxygen gas source, a fuel gas source, and a third gas source. The third gas source can be a mixture of hydrogen and oxygen gasses (HHO) or hydrogen gas (H₂) and can be added to the fuel gas source. The oxygen torch cutting system can include one or more gas lines, gas control valves, and flashback arrestors. The addition of HHO or H₂ gas to the fuel gas source can be facilitated by a tee connector. The inclusion of HHO or H₂ gas into the fuel gas source increases the efficiency of the oxygen cutting torch system by replacing a significant amount of the fuel with less expensive HHO or H₂ gas and increases the oxidation rate of metal and creates a cleaner flame.

### CROSS-REFERENCE TO RELATED APPLICATIONS

This application claims priority to pending U.S. Provisional Patent Application Ser. No. 63/306,866, titled “Oxygen Torch HHO Assisted Cutting System” and filed on Feb. 4, 2022, which is expressly incorporated by reference herein in its entirety

### FIELD OF THE INVENTION

The present invention relates generally to a torch cutting system and more specifically to an oxygen cutting torch system with a variable fuel ratio.

### BACKGROUND

Thermal cutting processes that use oxygen and a gaseous fuel (“Oxy-fuel cutting”) are a typical method of cutting metal. Oxy-fuel cutting involves the use of a cutting torch, the production of a flame, and the introduction of oxygen gas and a fuel source. The fuel source allows for production of a flame through the cutting torch while the oxygen gas is introduced to react with a portion of the heated metal that is being cut, removing the metal from the rest of the metal structure to form a cut in the metal. Oxy-fuel cutting systems use a variety of different fuel types, including, for example, Acetylene, Propane, propylene, acetylene, MAPP (i.e., methyl acetylene-propadiene propane), or natural gas. The heat of the flame produced differs based on the type of fuel used, as does the precision of the cut, the cleanness of the flame produced, the cost of use, and a variety of other properties. There is a need for an oxy-fuel cutting torch that can create a clean, precise, and sufficiently hot flame in an efficient and cost effective manner, while reducing the visible smoke and emissions during the cutting process.

### SUMMARY

The present disclosure is directed to an oxygen torch cutting system. In one embodiment, the oxygen torch cutting system comprises an oxygen source and a fuel source, as well as a third gas source that can be either a mixture of hydrogen and oxygen gasses at a 2:1 ratio (referred to as hydrogen-hydrogen-oxygen gas or its abbreviation “HHO”) or hydrogen gas (H₂) to supplement the fuel source. In addition to the fuel sources, oxygen torch cutting system comprises a variety of gas lines, gas control valves, and flashback arrestors, as well as a torch. The addition of HHO or H₂ gas to the fuel in an oxygen torch cutting system is done through a tee connector near the input of the fuel into the cutting torch. Introduction of HHO or H₂ gas into the fuel for use in cutting increases the efficiency of the cutting torch by replacing a significant amount of the fuel with less expensive HHO or H₂ gas. The use of HHO or H₂ gas in the system is also beneficial in that it increases the oxidation rate of metal and creates a cleaner flame.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 is an illustration of the oxygen supply and fuel supply for use in an embodiment of an oxygen torch cutting system.

FIG. 2 is an illustration of the HHO or H₂ gas generator for use in an embodiment of an oxygen torch cutting system.

FIG. 3 is an illustration of the tee connector for use in an embodiment of an oxygen torch cutting system.

FIG. 4 is an illustration of a torch for use in an embodiment of an oxygen torch cutting system.

FIG. 5 is an illustration of a control valve for use in an embodiment of an oxygen torch cutting system.

FIG. 6 is a diagram of the vent bypass system for use in an embodiment of an oxygen torch cutting system.

FIG. 7 is a diagram of an oxygen torch cutting system in accordance with at least one embodiment.

FIG. 8 is an illustration of an oxygen torch cutting system in accordance with at least one embodiment.

### DETAIL DESCRIPTION

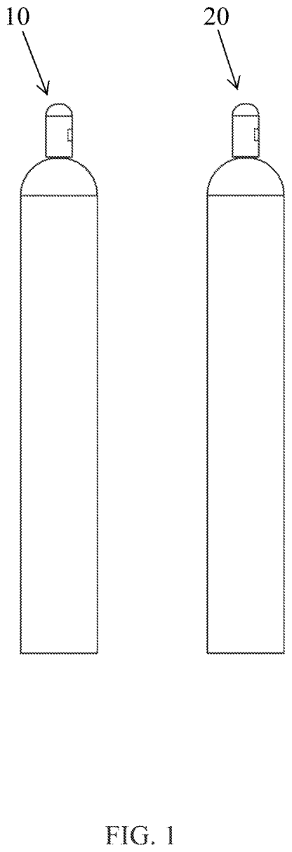

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of oxygen torch cutting systems are hereinafter disclosed and described in detail with reference made to FIGS. 1-8. All illustrations of the drawings are for the purpose of describing selected versions of embodiments and are not intended to limit the scope of the present disclosure.

The present disclosure describes and illustrates embodiments of oxygen torch cutting systems. In one embodiment, an oxygen cutting torch system includes a cutting torch, an oxygen supply, a fuel supply, an HHO or H₂ generator, a tee connector, one or more gas control valves, one or more flashback arrestors, one or more HHO vent systems, and a plurality of gas lines. The oxygen torch cutting systems as disclosed herein increase torch efficiency by allowing for adjustable incorporation of HHO or H₂ gas into either the fuel or both the fuel and oxygen systems. While the disclosure generally describes oxygen torch systems as incorporating either HHO or H₂ gas, it will be understood that in certain embodiments, both HHO and H₂ may be included in the fuel and/or oxygen streams.

Oxygen cutting torch systems utilizes oxygen, a fuel source, and either HHO or H₂ gas. The oxygen supply is provided by an oxygen gas cylinder 10, as illustrated in FIG. 1. The oxygen gas cylinder 10 may further comprise a pressure regulator (not shown) to regulate the flow rate of the oxygen flowing from the oxygen gas cylinder. In some embodiments, the flow rate of the oxygen can be adjusted by modifying the pressure regulator of the oxygen supply, or further downstream in a regulating or orifice. The oxygen gas cylinder 10 is connected to a first end of an oxygen line, which carries oxygen through the oxygen torch cutting system and ultimately to a cutting torch. The fuel supply is provided by a fuel gas cylinder 20, as illustrated in FIG. 1, holding any number of fuels that are appropriate for an oxygen torch cutting system. Typically, the fuel contained in the fuel gas cylinder 10 is propane, propylene, acetylene, MAAP, or natural gas. Similar to the oxygen gas cylinder 10, the fuel gas cylinder 20 may further comprise a pressure regulator (not shown) to regulate the flow rate of the fuel flowing from the fuel gas cylinder 20, or further downstream in a regulating valve or orifice. The fuel gas cylinder 20 is connected to a first end of a fuel line, which carries fuel through the oxygen torch cutting system, and ultimately to the cutting torch.

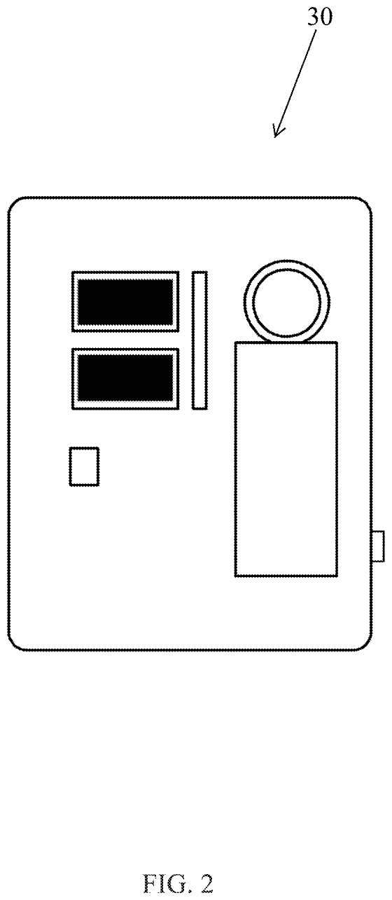

A supplemental gas generator 30 is illustrated in FIG. 2. The supplemental gas generator 30 can generate HHO gas, H₂ gas, or a combination of HHO and H₂ gas. HHO and H₂ gases are useful when using the oxygen torch cutting system to cut metals. As previously noted, HHO gas is a mixture of hydrogen and oxygen gases. The ratio of hydrogen to oxygen in the HHO gas is typically 2 to 1; however, mixtures comprising a higher portion of hydrogen may be used in the embodiments described. Such increased portion of hydrogen may be facilitated by the use of a pure hydrogen generator that creates pure hydrogen or hydrogen with a negligible percentage of oxygen gas. HHO and H₂ generators generally operate through water electrolysis, in which water molecules are dissociated through the flow of electric current. H₂ and O₂ gas may re-bond in gaseous form as HHO as expected in an HHO generator or be separated during the electrolysis process to form pure H₂ and O₂ gases, as expected in an H₂ generator. In the described embodiments, the HHO or H₂ gas generated by the HHO or H₂ generator may connect directly to an HHO or H₂ line, which carries HHO or H₂, gas, respectively, through the oxygen torch cutting system. In alternative embodiments, the HHO or H₂ generator may store HHO or H₂ gas in a separate HHO or H₂ gas cylinder. Either the HHO or H₂ generator itself or the HHO or H₂ gas cylinder may further comprise a pressure regulator to regulate the flow rate of the HHO or H₂ gas flowing out of the HHO or H₂ generator or HHO or H₂ gas cylinder. Furthermore, the oxygen torch cutting system may have a regulating valve or orifice further downstream of the supply. In some embodiments, the flow rate of the HHO or H₂ gas can be adjusted by modifying the pressure regulator. The HHO or H₂ generator or HHO or H₂ gas cylinder is connected to a first end of an HHO or H₂ gas line, which carries HHO or H₂ gas through the oxygen torch cutting system and ultimately to the cutting torch.

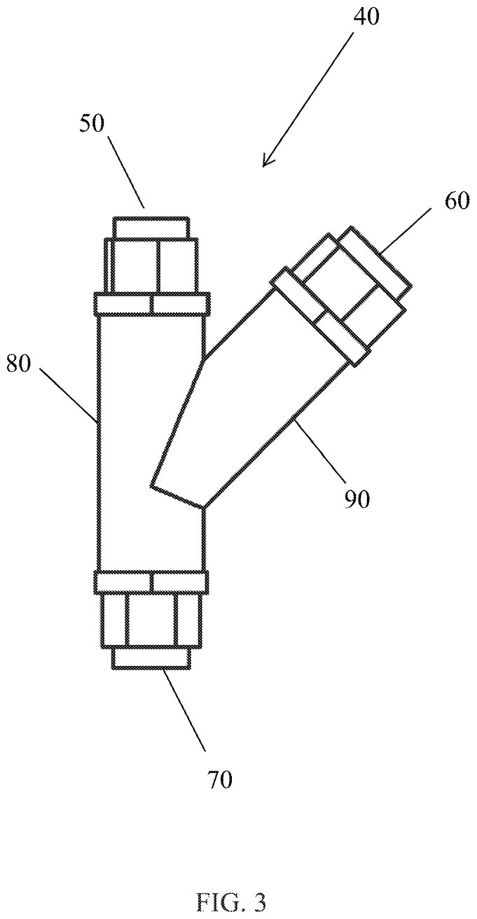

As illustrated in FIG. 3, a tee connector 40 for use with an oxygen torch cutting system comprises a fuel inlet port 50, an HHO or H₂ inlet port 60, and a mixed fuel outlet port 70 as well as a main tube 80 and an auxiliary tube 90. The main tube 80 connects the fuel inlet port 50 to the mixed fuel outlet port 70, while the auxiliary tube connects the HHO or H₂ inlet port 60 to the main tube 80. In the illustrated embodiment, HHO or H₂ gas is mixed with the fuel line in a manner that creates a zero to negative pressure drop along the HHO or H₂ line when fuel is flowing. In the illustrated embodiment this is represented as the auxiliary tube 90 positioned at approximately a thirty-five degree angle to the main tube 80. While the illustrated embodiment illustrates the auxiliary tube 90 positioned at approximately a thirty-five degree angle to the main tube 80, it will be understood that the zero or negative pressure drop can be accomplished by injection HHO or H₂ gas perpendicularly to the fuel flow (i.e., 90 degrees), parallel to the fuel flow (i.e., 0 degrees) or at any angle in between 0 and 90.

A second end of the earlier described fuel line connects to the fuel inlet port 50 of the tee connector 40, a second end of the HHO or H₂ gas line connects to the HHO or H₂ inlet port 60 of the tee connector 40, and a first end of a mixed fuel line connects to the mixed fuel outlet port 70 of the tee connector 40. In one embodiment the tee connector 40 can be positioned significantly closer to the cutting torch than the fuel gas cylinder 20 or HHO or H₂ generator 30. In other embodiments, HHO or H₂ gas may be injected at any point between the fuel source/supply and the cutting torch.

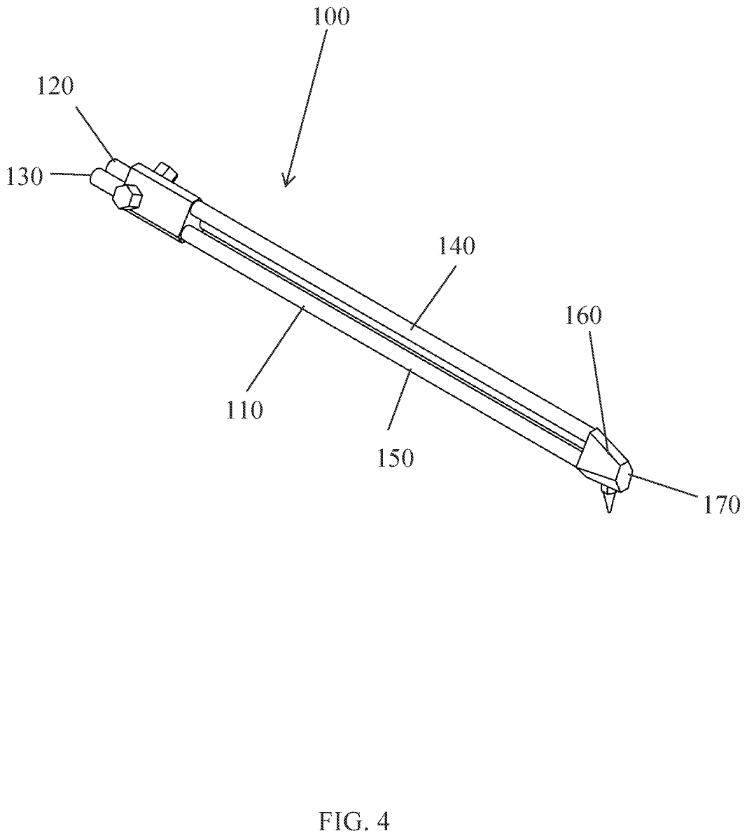

As illustrated in FIG. 4, the cutting torch 100 of the oxygen torch cutting system comprises a body 110 having at least two inlet ports 120, 130, at least two gas tubes 140, 150, a mixing chamber 160, and an outlet port 170, which serves as the cutting tip. The two inlet ports 120, 130 of the torch body 110 are arranged so that gas can flow through the cutting torch 100, with one of the inlet ports 120 arranged to engage with a second end of the oxygen line and the other inlet port 130 arranged to engage with a second end of the mixed fuel line. Each inlet port 120, 130 connects to a corresponding gas tube 140, 150. Each of the at least two gas tubes 140, 150 traverse the cutting torch body 110, connecting its corresponding inlet port 120, 130 to the mixing chamber 160 for the preheat flame. The outlet port 170 connects to the mixing chamber 160 opposite the gas tubes 140, 150 and allows for the mixed gas to exit the cutting tip of the cutting torch 100. In alternative embodiments of a cutting torch, a separate oxygen outlet may be provided to provide a stream of oxygen gas into the premix flame for enhanced cutting ability and/or efficiency. The outlet port 170 of the cutting torch 100 may be of any shape or length necessary to precisely expel the gas from the cutting torch 100. The cutting torch 100 as described may further comprise a variety of control mechanisms, including a plurality of gas tube valves, a mixing chamber valve, an outlet control valve, and a sparker. The gas tube valves allow the user to start and stop the flow of gas from each of the inlet ports to the gas tubes, the mixing chamber valve allows the user to start and stop the flow of gas from each of the gas tubes into the mixing chamber for the preheat flame, and the outlet control valve allows the user to start and stop the flow of gas (for example, oxygen) from the mixing chamber to the outlet port. The sparker may be included at the outlet of the cutting torch to ignite the gas as it is expelled from the cutting torch.

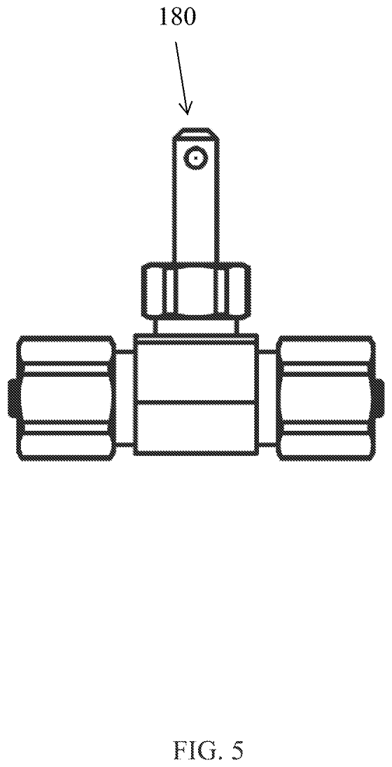

Each of the plurality of gas lines of the present invention, including the oxygen line, the fuel line, the HHO or H₂ gas line, and the mixed gas line, may further comprise control valves and a flashback arrestors. Each of the control valves may be a manual flow control valve, an automatic flow control valve, a solenoid valve, a diverter valve, a pressure release valve, a pressure regulator, or a pressure valve. An example of such a control valve 180 is illustrated in FIG. 5. Each of these valves may be used to control the pressure and flow rate of the various gasses throughout the oxygen torch cutting system. Each of the flashback arrestors may be placed at any point in any of the plurality of gas lines to ensure there is no reverse flow of gas in the system or propagation of flame down the gas lines. This is particularly important near the inlet ports of the cutting torch and the HHO or H₂ inlet port of the tee connector 40.

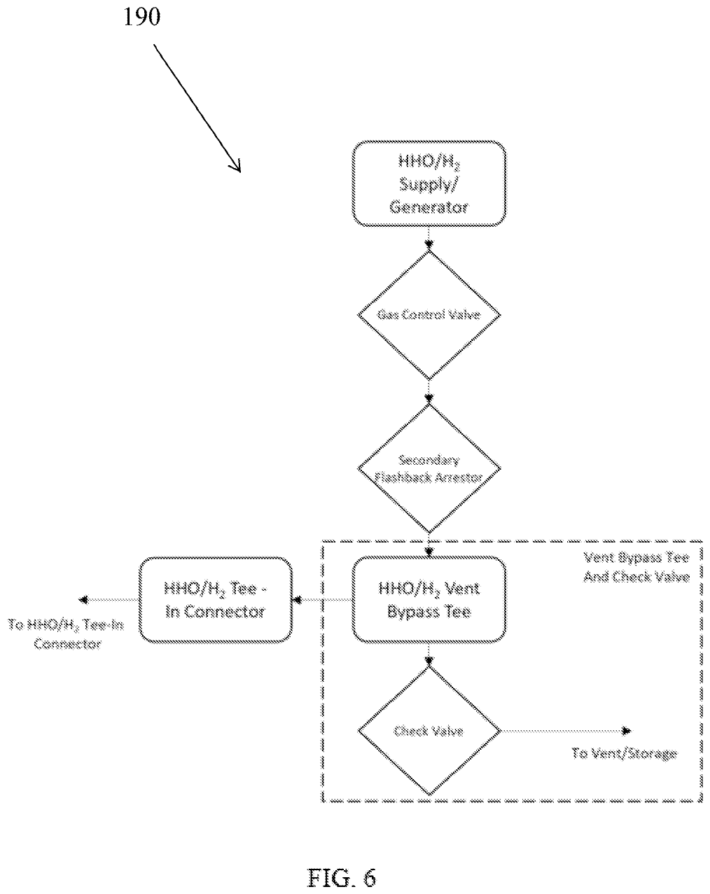

To accommodate pressure changes in the HHO or H₂ system, a vent system 190 may be used in the HHO or H₂ flow path as illustrated in FIG. 6 to reduce back pressure created from the torch cycling on and off by the operator or reaching an unsafe operating pressure for the HHO or H₂ generator. The vent system 190 comprises one or more check valves and appropriate connections and pressure lines to direct flow to either atmosphere or storage.

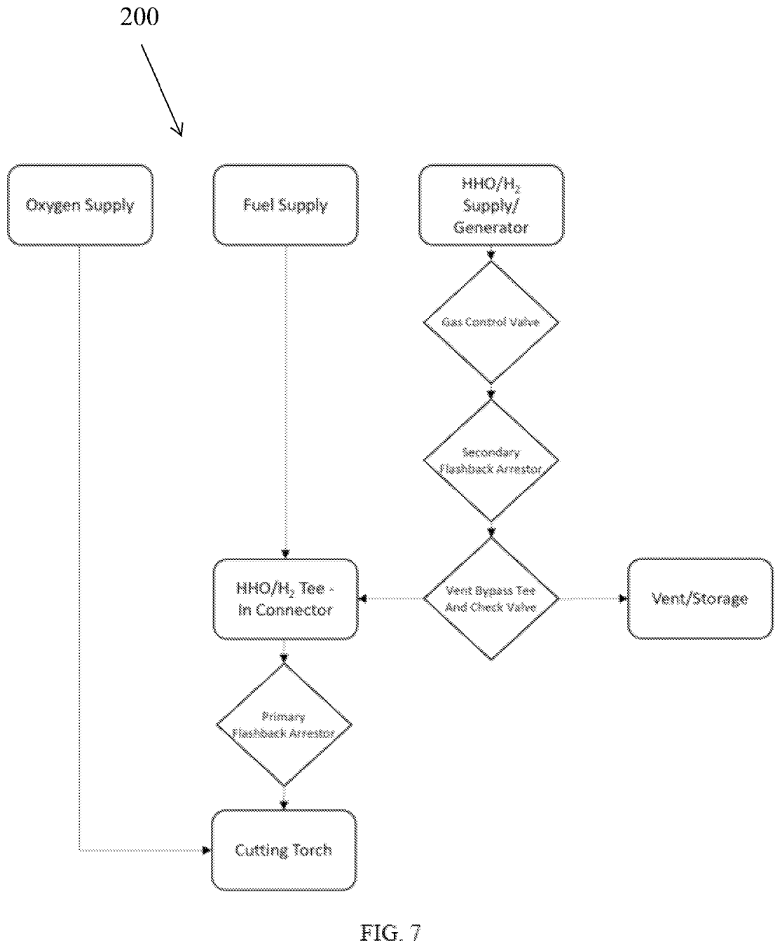

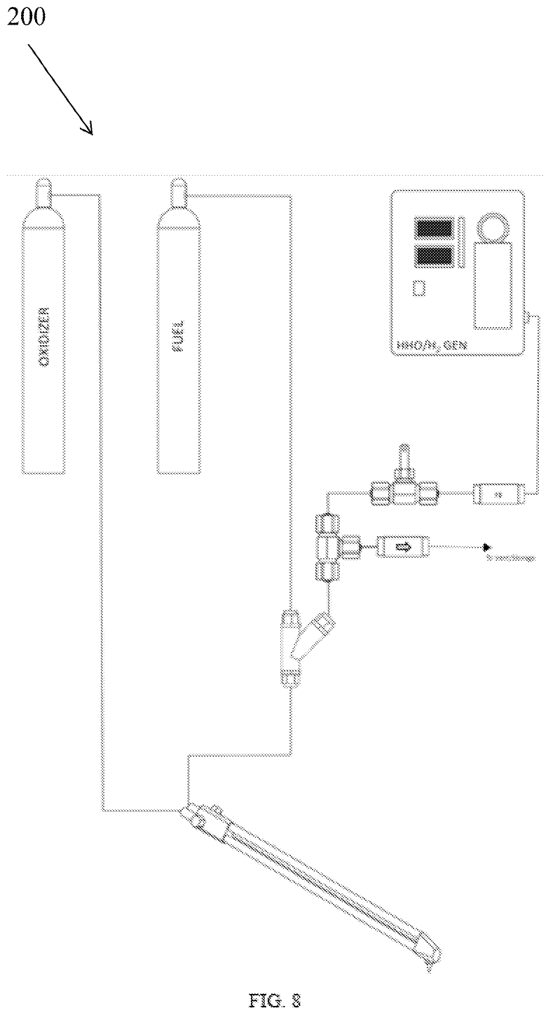

The connection of the components of the embodiment of the oxygen torch cutting system 200, as illustrated in FIG. 7 and FIG. 8, is now described. The oxygen source is connected to one of the inlet ports of the cutting torch by the oxygen line, the fuel source is connected to the fuel inlet port of the tee connector by the fuel line, and the HHO or H₂ generator is connected to the HHO or H₂ inlet port of the tee connector by the HHO or H₂ gas line. The outlet port of the tee connector is connected to one of the inlet ports of the cutting torch by the mixed fuel line. Any of the oxygen line, fuel line, HHO or H₂ gas line, or mixed fuel line may include one or more control valves and/or flashback arrestors. A user of the oxygen torch cutting system may control the flow of gas through the system by way of the pressure regulators, the HHO or H₂ generator, the control valves, and/or the control mechanisms of the cutting torch. Preferred operation of the system requires flow of fuel through the fuel line, tee connector, and mixed fuel line before directing HHO or H₂ gas to the tee connector in order to take advantage of the static pressure drop in the HHO or H₂ gas line and reduce flashback. In one embodiment, the components are sized and adjusted to provide between 10%-90% HHO or H₂ gas by volume to the mixed fuel line of the present invention.

Although the invention has been explained in relation to its preferred embodiment, it is to be understood that many other possible modifications and variations can be made without departing from the spirit and scope of the invention. The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. An oxygen torch cutting system comprising:
a cutting torch;
a source of oxygen gas;
a source of fuel gas; and
a source of HHO gas;
wherein the fuel gas and HHO gas are mixed prior to entering the cutting torch; and
wherein, the oxygen gas and mixture of the fuel and HHO gas are mixed in the cutting torch.

2. The oxygen torch cutting system of claim 1, wherein the oxygen gas is supplied from an oxygen gas cylinder.

3. The oxygen torch cutting system of claim 2, wherein the fuel gas is supplied from a fuel gas cylinder.

4. The oxygen torch cutting system of claim 3, wherein the HHO gas is suppled from a HHO gas generator.

5. The oxygen torch cutting system of claim 1, further comprising:
a tee connector comprising:
a main body;
an auxiliary body connected to the main body one a first end;
fuel inlet port located at a first end of the main body;
an HHO inlet port located at a second end of the auxiliary body; and
a mixed fuel outlet port 70 located at a second end of the main body.

6. The oxygen torch cutting system of claim 5, wherein the tee connector is arranged so that the fuel gas enters the tee connector through the fuel inlet port, the HHO gas enters the tee connector through the HHO inlet port, and a mixture of the fuel gas and HHO gas exit the tee connector through the mixed fuel outlet port.

7. The oxygen torch cutting system of claim 6, wherein the auxiliary port is arranged at an approximately 35 degree angle to the main body.

8. The oxygen cutting torch of claim 6, wherein the cutting torch includes a plurality of mechanism to control the amount of the mixture of the fuel gas and HHO gas and oxygen gas entering the cutting torch.

9. The oxygen cutting torch of claim 1, wherein the HHO gas is supplied from a HHO gas cylinder.

10. The oxygen cutting torch of claim 4, wherein the oxygen gas cylinder, fuel gas cylinder, and HHO generator each have a mechanism for controlling the amount of gas exiting the cylinder or generator respectively.

11. An oxygen torch cutting system comprising:
a cutting torch;
a source of oxygen gas;
a source of fuel gas; and
a source of hydrogen (H₂) gas;
wherein the fuel gas and H₂ gas are mixed prior to entering the cutting torch; and
wherein, the oxygen gas and mixture of the fuel and H₂ gas are mixed in the cutting torch.

12. The oxygen torch cutting system of claim 11, wherein the oxygen gas is supplied from an oxygen gas cylinder.

13. The oxygen torch cutting system of claim 12, wherein the fuel gas is supplied from a fuel gas cylinder.

14. The oxygen torch cutting system of claim 13, wherein the H₂ gas is suppled from a H₂ gas generator.

15. The oxygen torch cutting system of claim 11, further comprising:
a tee connector comprising:
a main body;
an auxiliary body connected to the main body one a first end;
fuel inlet port located at a first end of the main body;
an H₂ inlet port located at a second end of the auxiliary body; and
a mixed fuel outlet port 70 located at a second end of the main body.

16. The oxygen torch cutting system of claim 15, wherein the tee connector is arranged so that the fuel gas enters the tee connector through the fuel inlet port, the H₂ gas enters the tee connector through the H₂ inlet port, and a mixture of the fuel gas and H₂ gas exit the tee connector through the mixed fuel outlet port.

17. The oxygen torch cutting system of claim 16, wherein the auxiliary port is arranged at an approximately 35 degree angle to the main body.

18. The oxygen cutting torch of claim 16, wherein the cutting torch includes a plurality of mechanism to control the amount of the mixture of the fuel gas and H₂ gas and oxygen gas entering the cutting torch.

19. The oxygen cutting torch of claim 11, wherein the H₂ gas is supplied from a H₂ gas cylinder.

20. The oxygen cutting torch of claim 14, wherein the oxygen gas cylinder, fuel gas cylinder, and H₂ generator each have a mechanism for controlling the amount of gas exiting the cylinder or generator respectively.
